(19) United States
(12) Patent Application Publication
(10) Pub. No.: US 2010/0284298 A1
(43) Pub. Date: Nov. 11, 2010

(54) Method and Apparatus for Transmitting Information by Using Cyclic Prefix Timeslots

(75) Inventors: Linfeng Xia, Shenzhen (CN); Yi Luo, Shenzhen (CN); Yinggang Du, Shenzhen (CN); Peng Li, Shenzhen (CN); Minzhi Deng, Shenzhen (CN); Ping Yu, Shenzhen (CN); Mingxia Xu, Shenzhen (CN)

Correspondence Address: Slater & Matsil, L.L.P., 17950 Preston Road, Suite 1000, Dallas, TX, 75252, US

(73) Assignee: HUAWEI TECHNOLOGIES CO., LTD., Shenzhen (CN)

(21) Appl. No.: 12/840,675

(22) Filed: Jul. 21, 2010

Related U.S. Application Data
(63) Continuation of application No. PCT/CN2009/070250, filed on Jan. 21, 2009.

(30) Foreign Application Priority Data
Jan. 21, 2008 (CN) 200810004217.4
Feb. 5, 2008 (CN) 200810065358.7

(51) Int. Cl. H04L 12/26; H04J 3/00

(52) U.S. Cl. 370/252; 370/336

(57) ABSTRACT

A method for transmitting information by using Cyclic Prefix (CP) timeslots includes a transmitter transmitting CP information at a portion of CP timeslots when transmitting the timeslots or transmitting no CP information at CP timeslots when transmitting the CP timeslots. A method for using CP timeslots effectively and an apparatus for using CP timeslots are also disclosed.

This application is a continuation of co-pending International Application No. PCT/CN2009/070250, filed Jan. 21, 2009, which designated the United States and was not published in English, and which claims priority to Chinese Application No. 200810004217.4, filed Jan. 21, 2008, and Chinese Application No. 200810065358.7, filed Feb. 5, 2008, each of which is incorporated herein by reference.

### TECHNICAL FIELD

The present invention relates to mobile communications technologies, and in particular, to a method and apparatus for transmitting information by using cyclic prefix timeslots.

### BACKGROUND

With the development of communications technologies, better quality of information transmission is required. To resist the Inter-Symbol Interference (ISI) during high-speed transmission, an Orthogonal Frequency Division Multiplexing (OFDM) technology is adopted. OFDM divides a channel into many orthogonal sub-channels. The sub-channels are always orthogonal with an overlapped spectrum and thus the spectrum efficiency is increased. OFDM symbols are periodically extended. The last L samples of each symbol are replicated and placed before the symbol to form a Cyclic Prefix (CP). This makes the OFDM system less sensitive to synchronization errors so that the OFDM system can effectively resist the harm of multipath delay. As shown in FIG. 5, the last L samples of an OFDM symbol are replicated and placed before the symbol to form a CP.

Taking the application of OFDM in an Ultra Mobile Broadband (UMB) system as an example, the CP has four lengths, 6.51 μs, 13.02 μs, 19.53 μs, and 26.04 μs, to match different coverage areas of base stations.

Table 1 lists the CP lengths defined for the UMB system to match different coverage areas of base stations. For a synchronous system, the CP is consistent in entire network.

TABLE 1

| | FFT Size (N_{FFT}) | | | | | Unit of |
|---|---|---|---|---|---|---|
| Parameter | 128 | 256 | 512 | 1024 | 2048 | Measure |
| Chip rate | 1.2288 | 2.4576 | 4.9152 | 9.8304 | 19.6608 | Mcps |
| Sub-carrier | 9.6 | 9.6 | 9.6 | 9.6 | 9.6 | kHz |
| interval | | | | | | |
| Working | B ≦ 1.25 | 1.25 < B ≦ 2.5 | 2.5 < B ≦ 5 | 5 < B ≦ 10 | 10 < B ≦ 20 | MHz |
| bandwidth (B) | | | | | | |
| CP length | 6.51, 13.02, | 6.51, 13.02, | 6.51, 13.02, | 6.51, 13.02, | 6.51, 13.02, | μs |
| | 19.53, or 26.04 | 19.53, or 26.04 | 19.53, or 26.04 | 19.53, or 26.04 | 19.53, or 26.04 | |
| Protection | 3.26 | 3.26 | 3.26 | 3.26 | 3.26 | μs |
| window timeslot | | | | | | |
| OFDM symbol | 113.93, 120.44, | 113.93, 120.44, | 113.93, 120.44, | 113.93, 120.44, | 113.93, 120.44, | μs |
| length | 126.95, or 133.46 | 126.95, or 133.46 | 126.95, or 133.46 | 126.95, or 133.46 | 126.95, or 133.46 | |

In practice, the inventor finds that the solution provided by the prior art has at least the following problem.

In the case of a synchronous system, the conditions are different after femtocells are deployed in the UMB system.

Femtocells improve indoor coverage by installing a low-power base station indoors so as to enhance the indoor communications capability. In terms of implementation, a femtocell is the same as a normal base station. The difference is that a femtocell works at much lower power. The effective radius is therefore usually within tens of meters. For a communications system such as a femtocell with a small coverage area, because the distance is short, the multipath influence is slight. Also, because of the short distance, the precision of synchronization is also improved. In this case, the CP is insignificant. As the receiver discards the CP portion directly, a waste is caused.

According to the 802.11n model, the general indoor transmission delay is 80-1050 ns. In a UMB system, however, the length of a CP is 1/16 of the length of an OFDM symbol. The length of an OFDM symbol is 113.93 μs and therefore the length of a CP is between 6.51 μs and 26 μs. It is obvious that the waste of the CP portion is great.

Take a 5M system as an example. The length of a chip is about 200 ns and the maximum delay is the length of 5 chips. The CP portion consumes the length of 32-128 chips. The waste is obvious.

### SUMMARY OF THE INVENTION

In one aspect, the present invention provides a method and system for using CP timeslots effectively so as to enhance the system performance and increase the system throughput.

A method for using CP timeslots effectively includes, a transmitter transmitting CP information at a portion of CP timeslots when transmitting the CP timeslots, the transmitter transmitting no CP information at CP timeslots when transmitting the CP timeslots.

Another method for using CP timeslots effectively includes transmitting, by a transmitter, CP information at a portion of CP timeslots. A Cognitive Radio (CR) device tests the CP. The CR device predicts periodicity of an idle portion of the CP. The CR device uses a resource corresponding to the CP if the CR device determines that the resource corresponding to the CP is periodically idle.

An apparatus for using CP timeslots effectively includes a first transmitting unit that is adapted to transmit CP information at a portion of CP timeslots when transmitting the CP timeslots or a second transmitting unit that is adapted not to transmit CP information at CP timeslots when transmitting the CP timeslots.

A method for using Cyclic Prefix (CP) timeslots effectively includes receiving, by a receiver, a signal transmitted by a transmitter at CP timeslots and obtaining information transmitted by the transmitter according to power change of the signal.

A receiver for using Cyclic Prefix (CP) timeslots comprises a testing unit that is adapted to test power of signal received at the CP timeslots. A comparing unit is adapted to compare test result with a predefined threshold, and determine the information as “1” if the test result is above the threshold and determine the information as “0” if the test result is below the threshold; or to determine the information as “0” if the test result is above the threshold and determine the information as “1” if the test result is below the threshold. An obtaining unit is adapted to obtain the information transmitted by the transmitter according to the determination of the comparing unit.

To resolve the waste of CP timeslots in the prior art because CP timeslots are not processed, on the one hand of the embodiments of the present invention, the CP timeslots are not used to transmit information, that is, the timeslots are silent, which can be used in background noise testing or the detection of idle resources by a CR device; on the other hand, CP timeslots are used to transmit additional information. Both the above two solutions can increase the utilization of CP timeslots and reduce the waste of CP timeslots. Moreover, through utilization of the CP timeslots, the system performance is enhanced and the system throughput is increased.

### BRIEF DESCRIPTION OF THE DRAWINGS

FIG. 1 illustrates a procedure of a first information processing method according to an embodiment of the present invention;

FIG. 2 illustrates a procedure of a second information processing method according to an embodiment of the present invention;

FIG. 3A and FIG. 3B illustrate a structure of an apparatus for using CP timeslots effectively according to an embodiment of the present invention;

FIG. 4A illustrates a structure of a system for using CP timeslots effectively according to an embodiment of the present invention;

FIG. 4B illustrates a procedure of a method for using CP timeslots effectively according to an embodiment of the present invention;

FIG. 5 illustrates an OFDM symbol transmitted by a normal base station in the prior art;

FIG. 6 is a first schematic drawing when CP timeslots are transmitted at a portion of power or zero power according to an embodiment of the present invention;

FIG. 7 is a second schematic drawing when CP timeslots are transmitted at a portion of power or zero power according to an embodiment of the present invention;

FIG. 8 is a third schematic drawing when CP timeslots are transmitted at a portion of power or zero power according to an embodiment of the present invention;

FIG. 9 is a schematic drawing of indicating binary information with the power change of CP timeslots according to an embodiment of the present invention;

FIG. 10 illustrates the binding of CP timeslots according to an embodiment of the present invention; and

FIG. 11 is a schematic drawing of indicating multi-notation information with the power change of CP timeslots according to an embodiment of the present invention.

### DETAILED DESCRIPTION OF ILLUSTRATIVE EMBODIMENTS

In a first method provided according to an embodiment of the present invention, CP timeslots are not all used to transmit the CP; CP timeslots can be used to transmit information, or the CP timeslots can be used to transmit no information, that is, the CP timeslots are silent.

In the following solutions, CP timeslots may be used to transmit information over the forward link, for example, from the base station to the terminal, or over the reverse link, for example, from the terminal to the base station. Hereinafter, the technical solution of the present invention is explained based on only transmission over the forward link. The principle of transmission over the reverse link is the same.

The solution will be described with respect to the following four solutions.

Solution 1: The base station does not transmit any information at the CP timeslots, that is, the CP timeslots are not power-loaded but the period of the CP timeslots is still vacant. The CP timeslots may be silent and used to measure forward background noises.

Solution 2: The base station reserves a portion of CP timeslots to carry CP information and the other portion of CP timeslots transmit no information. Compared with the prior art, solution 2 reduces the length of timeslots used to carry CP information and remainder of the CP timeslots may be silent.

Solution 3: The base station reserves a portion of CP timeslots to carry CP information and the remainder of the CP timeslots may be used to transmit information. This solution is similar to solution 2 but differs in that timeslots other than those used to carry CP information are used to transmit information. The information transmitted at CP timeslots may be processed in different methods, for example, following the same procedure as the existing data processing method. In the indoor model of UMB systems, it is only required that about a 1 μs CP timeslot be reserved, that is, the reserved timeslot can meet the requirement of the maximum transmission delay of the indoor model, corresponding to about five chips in a 5M UMB system. In this case, the procedure of the existing data processing method can be adopted. During the data processing, however, Inverse Fast Fourier Transform (IFFT) points need to be reduced to 32-128 points.

Solution 4: The base station transmits information at all CP timeslots. The information carried at the CP timeslots may be processed in any manner. This is the same as the processing in solution 3.

All of the above solutions are compatible with the existing terminals. Terminals incapable of processing CP timeslots can ignore the CP portion; terminals capable of processing CP information can use different receivers to process CP timeslots that transmit no information or process information transmitted at CP timeslots. Which processing method is adopted depends on the indication of a system message.

Further, in the case of solution 1 and solution 2, a CR mechanism can be defined. The CR mechanism tests available resources and predicts their periodicity. Once it is determined that a resource is periodically idle, the resource is used. The specific implementation is as follows:

a CR device tests a CP;

the CR device predicts the periodicity of the idle portion of the CP; and

if the CR device determines that the resource corresponding to the CP is periodically idle, the CR device uses the resource corresponding to the CP.

This is unlike the existing CR mechanism. The existing CR mechanism decides to use a resource only if it detects that the idle duration of the resource is long. With the CR mechanism in the embodiments of the present invention, the time for detection of available resources is shorter and the resource utilization will be increased.

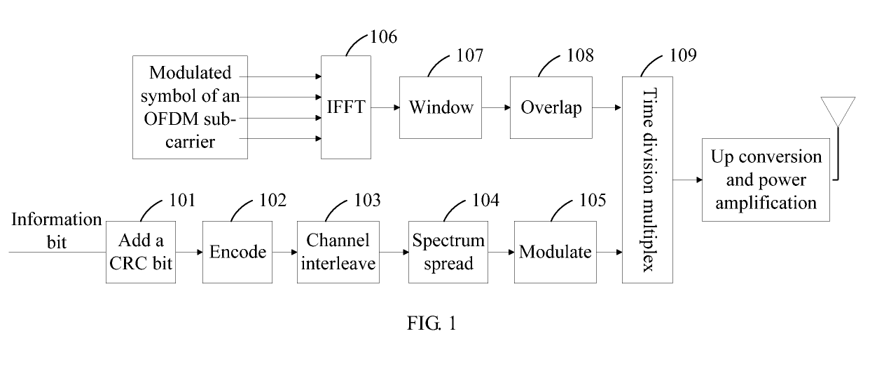

Further, in the case of solution 3 and solution 4, an information processing mechanism can be defined. Information can be carried at CP timeslots through the information processing mechanism. FIG. 1 illustrates the procedure of a first information processing method according to an embodiment of the present invention. The implementation is as follows:

modulate the information to be carried to obtain the modulated information; and

time-division-multiplex the modulated information with the CP.

The procedure for modulating the information to be carried includes.

Step 101: Add a Cyclic Redundancy Check (CRC) bit to the information bits to obtain the CRC-checked information.

Step 102: Encode the CRC-checked information to obtain the encoded information.

Step 103: Perform channel interleaving on the encoded information to obtain the interleaved information.

Step 104: Spread the spectrum of the interleaved information to obtain the spectrum-spread information.

Step 105: Modulate the spectrum-spread information to obtain the modulated information.

In the case that a portion of CP timeslots carry information, the procedure for time-division-multiplexing the modulated information with the CP includes:

Step 106: Perform an IFFT on the modulated symbols of the OFDM sub-carrier to obtain the transformed symbols.

Step 107: Window the transformed symbols to obtain the windowed symbols.

Step 108: Overlap the windowed symbols to obtain the overlapped symbols.

Step 109: Time-division-multiplex the overlapped symbols with the modulated information obtained in step 105.

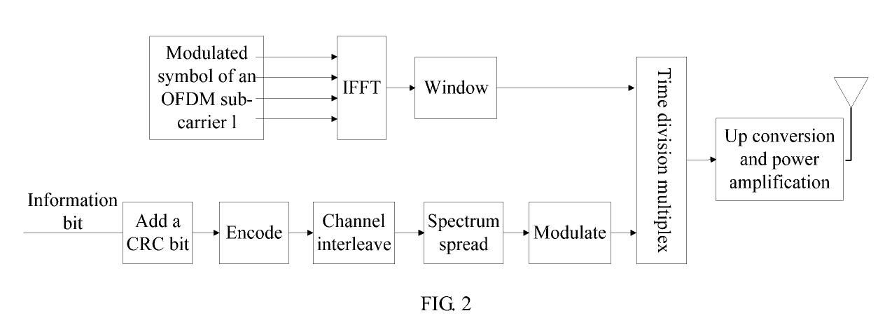

FIG. 2 illustrates the procedure of a second information processing method with respect to the case that all CP timeslots carry information. Comparing with the procedure where a portion of PC timeslots carry information, step 108 need not be included in the procedure for time-division-multiplexing the modulated information with the CP. Instead, the windowed symbols obtained in step 107 are directly time-division-multiplexed with the modulated information obtained in step 105.

If the system has specified the use mode of CP timeslots, it is unnecessary to add a parameter indication. If the system does not specify the use mode of CP timeslots, to support the above four solutions, a parameter indication, for example, CP information type, may be added to broadcast the use of CP timeslots. The parameter indication will be described by taking a UMB system as an example. The system must broadcast the use of CP timeslots on the basis of compatibility. For this purpose, n bits are added to indicate the use of CP timeslots. Assuming 2 bits are added, the indication of the bits is as follows:

00. All CP timeslots are used to carry the CP.

01. A portion of CP timeslots are used to carry the CP and the remaining portion is silent. According to the indoor model, the CP portion is about 1 μs by default, that is, the maximum transmission delay of the indoor model, corresponding to about five chips in the 5M UMB system.

10. A portion of CP timeslots are used to carry the CP and the remaining portion of the timeslots are used to transmit information. The CP portion is 1 μs by default, that is, the maximum transmission delay of the indoor model, corresponding to five chips in the 5M UMB system.

11. All the CP timeslots are used to transmit information.

The number of bits indicating the CP information type is not limited to two. In addition to indicating whether the CP timeslots carry information, the bits may also indicate the purpose of the CP timeslots in different modes. For example, in Frequency Division Duplex (FDD) mode, the purposes of forward CP timeslots and reverse CP timeslots may be different. In this case, four bits may be used.

The CP information type may be carried in different modes. Taking UMB as an example, the following modes are provided.

Mode 1: Table 2 shows the transport payload format of the existing Forward Primary Broadcast Channel (F-PBCCH). The Reserved field of the F-PBCCH may be used to carry the CP information type.

TABLE 2

| Field | Length (bits) |
|---|---|
| Initial Protocol Set ID 0 | 4 |
| Initial Protocol Set ID 1 | 4 |
| Initial Protocol Set ID 2 | 4 |
| Initial Protocol Set ID 3 | 4 |
| Least Significant Bits of System | 9 |
| Time Parameter | |
| Sub-carriers | 3 |
| Protective Sub-carriers | 6 |
| Truncated Channel IDs | 2 |
| Forward Link Reserved Intervals | 4 |
| Forward Link Reserved Intervals | 4 |
| Reserved | 0-7 |

Mode 2: Table 3 shows the transport payload format of the existing Forward Quick Paging Channel (F-QPCH). The Reserved field of F-QPCH may be used to carry the CP information type.

TABLE 3

| Field | Length (bits) |
|---|---|
| Load Control | 3 |
| Quick-Page-Block | 35 |
| Reserved | 6 |

Mode 3: Table 4 shows the transport payload format of the TDM Pilot 3 channel when Globally-Synchronous is set to 0. Table 5 shows the transport payload format of the TDM Pilot 3 channel when Globally-Synchronous is set to 1. The Reserved field of the 3 TDM Pilot 3 channel may be used to carry the CP information type.

TABLE 4

| Field | Bits | Description |
|---|---|---|
| Globally-Synchronous | 1 | The bit is set to 0. |
| Half-Duplex-Enable | 1 | If half duplex is supported, the |
| | | bit is set to 1 or else to 0. |
| Least Significant Bits | 4 | This field includes the least |
| of Super Frame Index | | signification four bits of a super |
| | | frame index. |
| Reserved | 3 | Reserved bits. |

TABLE 5

| Field | Bits | Description |
|---|---|---|
| Globally-Synchronous | 1 | The bit is set to 1. |
| Preamble-FDM-Enable | 1 | If preamble frequency division |
| | | multiplexing is supported, the bit |
| | | is set to 1 or else to 0. |
| Half-Duplex-Enable | 1 | If half duplex is supported, the |
| | | bit is set to 1 or else to 0. |
| Reserved | 6 | Reserved bits. |

Mode 4: The CP information type may also be carried in the Reserved field in the transport payload of the Forward Secondary Broadcast Channel (F-SBCCH).

If the CP timeslots do not carry information (solution 1 and solution 2), a terminal or an associated CR device may be notified of the CP information type only through broadcast. If the CP timeslots carry information (solution 3 and solution 4), in addition to the broadcast notification of the use of CP timeslots that the CP timeslots carry information, an assignment message must also be used to notify the terminal of the timeslot that uses the transmitted information. Therefore, a new assignment message must be defined. The new assignment message includes at least two fields of Message Type and Packet Format (PF). The processing of the new assignment message is the same as the processing of the prior assignment message. To discriminate the forward link and the reverse link, two types of new assignment message may be adopted. One type is used to indicate the CP in the forward link from the base station to the terminal; the other type is used to indicate the CP in the reverse link from the terminal to the base station. Alternatively, one type of new assignment message is adopted and a flag field is added before the new assignment message to indicate the forward link and the reverse link. For example, a 1-bit flag field is set. If the flag bit is 1, it indicates the forward link and if the flag bit is 0, it indicates the reverse link.

The base station sends the assignment message to the terminal associated with the information carried in the CP, instructing the terminal to use the information obtained from the timeslot.

Further, in a femtocell system or a system with a global CP, the solution where the CP timeslots carry no information or carry information may be adopted. If adjacent base stations that must be synchronized use different CPs, or if two or more cells that must be synchronized use different CPs, the CPs of the cells are extended to the same and the extended portion of the CPs carry the information. For example, when the CPs of cell 1, cell 2, and cell 3 satisfy CP1<CP2<CP3, and the three cells must be synchronized, the CPs of cell 1, cell 2, and cell 3 are all extended to CP3. A portion of or all CP3-CP2 timeslots are used to transmit information, or used to transmit no information, that is, the timeslots are silent. A portion of or all CP3-CP1 timeslots are used to transmit information, or used to transmit no information, that is, the timeslots are silent.

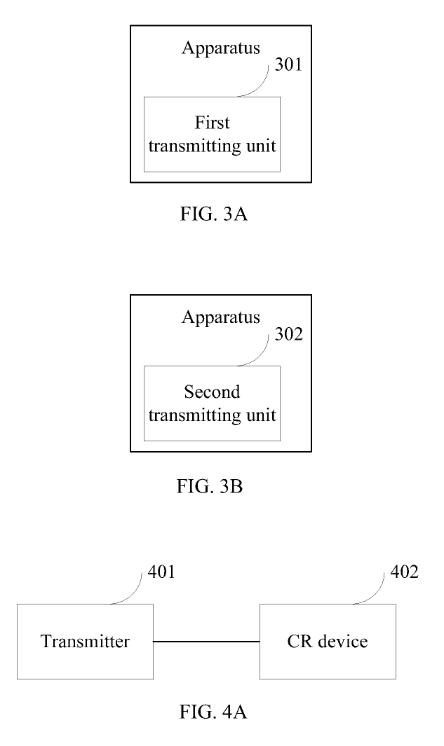

FIG. 3A and FIG. 3B illustrate the structure of an apparatus for using CP timeslots effectively according to an embodiment of the present invention. The apparatus may be a stand-alone device, or integrated in a base station, or integrated in a terminal.

The apparatus for using CP timeslots effectively according to the embodiment of the present invention is shown. A first transmitting unit 301 is adapted to transmit CP information at a portion of CP timeslots when transmitting the CP timeslots. Alternatively, a second transmitting unit 302, adapted not to transmit CP information at the CP timeslots when transmitting the CP timeslots.

The technical solution provided in the embodiment of the present invention can increase the utilization of CP timeslots and reduce the waste of CP timeslots. Moreover, by utilizing the CP timeslots, the technical solution will enhance the system performance and increase the system throughput.

The first transmitting unit includes a first transmitting module that is adapted to reserve a portion of CP timeslots to carry CP information and use the remaining portion of CP timeslots to transmit no information or a second transmitting module that is adapted to reserve a portion of CP timeslots to carry CP information and use the remaining portion of CP timeslots to transmit information other than the CP information.

The second transmitting unit includes a third transmitting module that is adapted not to load power at the CP timeslots or a fourth transmitting module that is adapted to transmit information other than the CP information at the CP timeslots.

The apparatus may further include a power controlling unit that is adapted to control the first transmitting unit or the second transmitting unit to transmit information at full power, or zero power, or low power at the CP timeslots.

The second transmitting module may include a modulating submodule that is adapted to modulate the information other than the CP information to obtain the modulated information other than the CP information. A multiplexing submodule is adapted to time-division-multiplex the modulated information other than the CP information with the CP.

The fourth transmitting module may include a modulating submodule that adapted to modulate the information other than the CP information to obtain the modulated information other than the CP information. A multiplexing submodule is adapted to time-division-multiplex the modulated information other than the CP information with the CP information.

Further, to meet the characteristic of the information carried at a CP timeslot, a receiver may be provided to receive the information carried at the CP timeslot transmitted by the apparatus. In this case, the receiver is adapted to receive the signal transmitted by the transmitter at the CP timeslot and obtain the information transmitted by the transmitter according to power change of the signal.

If the apparatus provided in the embodiment of the present invention transmits information according to the power change of the CP timeslot signal, the receiver provided according to the embodiment of the present invention may further include a testing unit that is adapted to test the power of the signal received at the CP timeslot. A comparing unit is adapted to: compare test result with a predefined threshold, and determine the information as “1” if the test result is above the threshold and determine the information as “0” if the test result is below the threshold; or determine the information as “0” if the test result is above the threshold and determine the information as “1” if the test result is below the threshold. An obtaining unit is adapted to obtain the information transmitted by the transmitter according to the determination of the comparing unit.

With the testing unit and the comparing unit to test and compare the power of the signal received at the CP timeslot, the obtaining unit can obtain the information indicated by the transmitter through the power change. This information transmission method is easy and accurate. The solution is highly feasible and therefore the application prospects are good.

The apparatus in the embodiment of the present invention may further include a third transmitting unit that is adapted to send an assignment message to the receiver associated with the information carried in the CP, where the assignment message instructs the receiver to use the timeslot that carries the information.

The apparatus in the embodiment of the present invention may further include a processing unit that is adapted to encode, interleave, and scramble the information to be transmitted when the CP timeslot is used to transmit information other than the CP information.

The information to be transmitted may include: system broadcast message, or multicast message, or control information, or user data.

The apparatus in the embodiment of the present invention may be a base station or a terminal.

In the case of a base station, the apparatus further includes a broadcasting unit that is adapted to broadcast the CP information type which indicates the use of the CP.

If the base station is located in a UMB system, the broadcasting unit broadcasts the CP information type over the F-PBCCH, or F-QPCH, or F-SBCCH, or TDM Pilot channel.

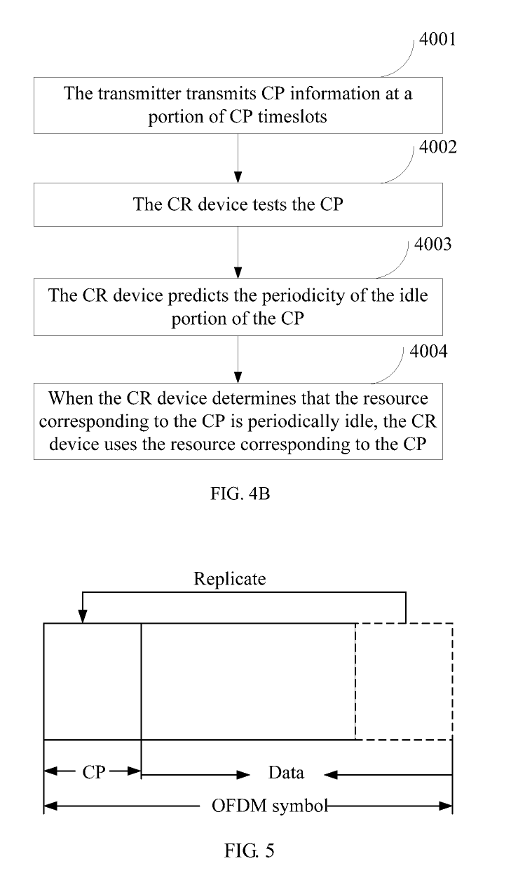

As shown in FIG. 4A, a system for using CP timeslots according to an embodiment of the present invention includes a transmitter 401 that is adapted to transmit CP information at a portion of CP timeslots. A CR device 402 is adapted to test the CP and predict the periodicity of the idle portion of the CP and use the resource corresponding to the CP if determining that the resource is periodically idle.

The technical solution provided in the embodiment of the present invention can increase the utilization of CP timeslots and reduce the waste of CP timeslots. Moreover, by utilizing the CP timeslots, the technical solution will enhance the system performance and increase the system throughput. As shown in FIG. 4B, a method for using CP timeslots according to an embodiment of the present invention includes the following steps.

Step 4001: The transmitter transmits CP information at a portion of CP timeslots.

Step 4002: The CR device tests the CP.

Step 4003: The CR device predicts the periodicity of the idle portion of the CP.

Step 4004: If the CR device determines that the resource corresponding to the CP is periodically idle, the CR device uses the resource corresponding to the CP.

The technical solution provided in the embodiment of the present invention can increase the utilization of CP timeslots and reduce the waste of CP timeslots. Moreover, by utilizing the CP timeslots, the technical solution will enhance the system performance and increase the system throughput.

On the basis of the aforementioned embodiments, the processing of the CP by the transmitter and the receiver may be changed to avoid the waste of CP timeslots. In the embodiments of the present invention, the CP timeslots may be used to transmit the CP, or transmit the CP or other predetermined signals at zero or low power. The transmitter controls the power of the CP timeslots and regards the change of power as information. Thus, the embodiments of the present invention increase the utilization of CP timeslots and reduce the waste of CP timeslots. In addition, through utilization of the CP timeslots, the system performance is enhanced and the system throughput is increased.

Hereinafter, the exemplary implementation of transmitting information at the CP timeslots in the embodiments of the present invention will be described.

First, by utilizing the feature that the CP timeslots of OFDM symbols may transmit the CP. The CP timeslots of OFDM symbols may also be transmitted at zero power or very low power and background noise information can be obtained.

The transmitter transmits information through the change of power of the CP timeslots in the OFDM symbols. For example, transmitting the CP at full power indicates the binary information “1” and transmitting the CP at zero power or a portion of power indicates the binary information “0”. Or, transmitting the CP at full power indicates the binary information “0” and transmitting the CP at zero power or a portion of power indicates the binary information “1”. For description purposes, hereinafter transmitting the CP at full power indicates the binary information “1” and transmitting the CP at zero power or a portion of power (low power) indicates the binary information “0”. This does not constitute any limitation to the embodiments of the present invention. If a CP timeslot transmits an OFDM symbol at full power, the transmitting mode is the same as that of a common base station and uses the same CP timeslot length. As shown in FIG. 5, the signal transmitted may be the CP or another predetermined signal. If the CP timeslot is transmitted at a portion of power or zero power, three transmitting modes can be used. The signal transmitted at the CP timeslot may be the CP or another predetermined signal.

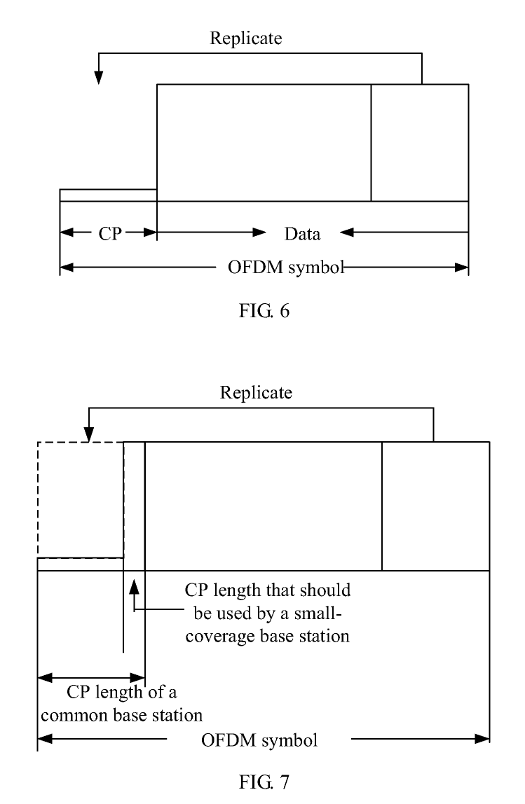

In the first mode, the transmitting mode is the same as the transmitting mode of a common base station; the same CP timeslot length is used but the transmit power in all CP timeslots is obviously below the full power and the transmitted signal may be the CP or another predetermined signal. The first transmitting mode is shown in FIG. 6.

In the second mode, the transmitting mode is the same as the transmitting mode of a common base station and the same CP timeslot length as the common base station is used; the transmitted signal is the CP or another predetermined signal, but the portion of CP timeslot that should be used by a small-coverage base station is transmitted at full power and the remaining portion is transmitted at low power. The second transmitting mode is shown in FIG. 7.

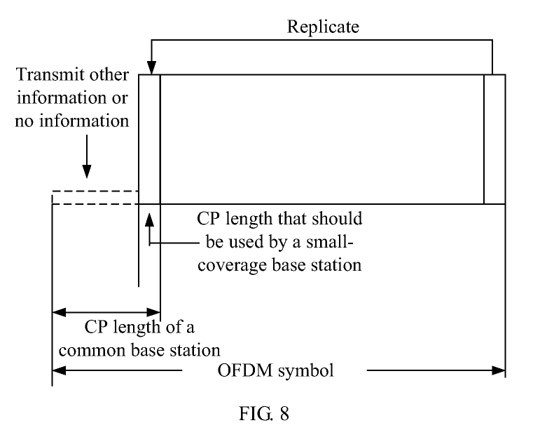

The third mode is similar to the second mode but the signal transmitted by the full-power portion can be independent of the signal transmitted by the low-power portion, and the low-power portion may even transmit no signal, as shown in FIG. 8.

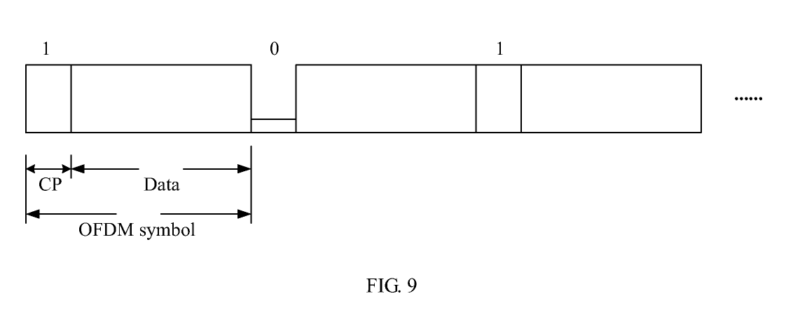

The base station transmits binary information in the CP in the above modes. As shown in FIG. 9, the transmission of the CP timeslot in the first OFDM symbol uses full power and the receiver determines the power (energy) of the CP timeslot after receiving the OFDM symbol. A common power detection method is: a known signal and a received signal are correlated and the obtained correlation value can be regarded as a power value. For example, If the signal transmitted at the CP portion is still the CP, the receiver may find a known signal corresponding to the CP timeslot according to the detected OFDM signal and correlates the known signal with the signal received at the CP timeslot. The known signal may be a predefined signal or a CP signal that should be generated according to the existing CP generation method with the detected OFDM signal. If the detected power exceeds a threshold T, the CP timeslot is regarded to indicate the binary information “1”. In the second OFDM symbol, the CP timeslot is transmitted at very low power or zero power. The receiver determines the CP energy is below the threshold T after receiving the OFDM symbol and considers that the CP timeslot indicates the binary information “0”. Thus, in three successive OFDM symbols, the example shown in FIG. 9 can carry the binary information “101” in three CP timeslots. By analogy, the CP timeslots of more OFDM symbols can be utilized to carry more information. In a UMB system, for example, a normal physical frame includes 8 OFDM symbols and the CP timeslots of the 8 OFDM symbols can carry binary information of 8 bits. The threshold may be predefined or dynamically adjusted. For example, an existing threshold is corrected by a value obtained according to a tested CP timeslot of low power or zero power or a value obtained according to a silent test frame.

One super frame includes a preamble and 25 common physical frames. Thus, the super frame includes 8×25=200 CP timeslots. All or a portion of the 200 CP timeslots are used to transmit information. Under an ideal circumstance, the 200 CP timeslots can carry the information of 200 bits. Considering test errors, multiple CP timeslots can be bound. When binary codes are transmitted, a number of CP timeslots may be defined to carry one bit information. In testing, the energy of CP timeslots is added or added after being multiplied by respective weights to get a result. If the result is above a defined threshold, the CP timeslots are considered to carry the bit “1” and if the result is below the defined threshold, the CP timeslots are considered to carry the bit “0”. For example, 2 CP timeslots indicate one bit. In this case, the 2 CP timeslots can carry 100 bits.

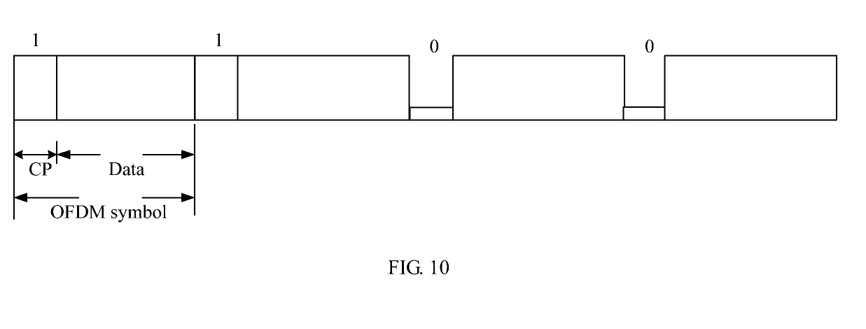

As shown in FIG. 10, the transmitter transmits the CP timeslots in the first and second OFDM symbols at full power and transmits the CP timeslots in the third and fourth OFDM symbols at very low power. The receiver combines the received CP energy of the first and second OFDM symbols and compares the combined energy with the threshold T. If the combined energy is above the threshold, the receiver considers that the CP timeslots in the first and second OFDM symbols carry the binary bit “1”. Likewise, the receiver combines the received CP energy of the third and fourth OFDM symbols and compares the combined energy with the threshold T. If the combined energy is below the threshold, the receiver considers that the CP timeslots in the third and fourth OFDM symbols carry the binary bit “0”. The two bound CP timeslots may be successive or not successive.

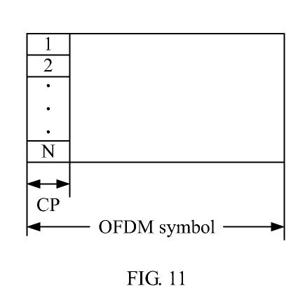

Further, the CP timeslot power may be quantized and divided into a number of sections from full-power to zero-power (considering power amplification, zero power is equivalent to very low power). By dividing the CP timeslot power into different power sections, one CP timeslot can carry multiple binary bits or multi-notation information. As shown in FIG. 11, the CP timeslot power is divided into N sections from full power to zero power within one OFDM symbol. In this case, the CP timeslot can carry log₂ N binary bits. The receiver compares the received CP timeslot section power with N−1 thresholds and obtains the information carried at the CP timeslot.

To guarantee correct transmission, the transmitter may encode, interleave, and scramble the information indicated by the CP timeslot, thus improving the reliability of reception. This will not be described here. The information indicated by the CP timeslots may be used to carry system broadcast information, or multicast information, or control information, or transmit user data.

To support the above solution, the system must define a new parameter indication to broadcast the use of CP timeslots, including but not limited to how to quantize the power of the CP timeslots, how to set CP timeslot binding, and whether to use all or a portion of CP timeslots. The indication may be carried by a broadcast channel or a control channel, or default or predefined information carried at the CP timeslot.

If the CP timeslot transmits user data, a new assignment message must be defined to notify the terminal how to use the resource.

If adjacent base stations use different CPs, synchronization is an inevitable issue. In this case, an operator can define that the larger CP is used but a portion of the CP of the small-coverage cell can transmit data.

Through the descriptions of the preceding embodiments, those skilled in the art may understand that the present invention may be implemented by using hardware only or by using software and a necessary universal hardware platform. However, in most cases, using software and a necessary universal hardware platform are preferred. Based on such understandings, all or part of the technical solution under the present invention that makes contributions to the prior art may be essentially embodied in the form of a software product. The software product may be stored in a storage medium, which can be a magnetic disk, a Compact Disk Read-Only Memory (CD-ROM), a Read-Only Memory (ROM) or a Random Access Memory (RAM). The software product includes a number of instructions that enable a computer device (personal computer, server, or network device) to execute the methods provided in the embodiments of the present invention.

It should be noted that the above descriptions are merely preferred embodiments of the present invention, and person having ordinary skill in the art may make various improvements and refinements without departing from the spirit of the present invention. All such modifications and refinements are intended to be covered by the present invention.

What is claimed is:

1. A method for effectively using Cyclic Prefix (CP) timeslots, the method comprising:
transmitting CP information at only a portion of CP timeslots when transmitting the CP timeslots; or
transmitting no CP information at CP timeslots when transmitting the CP timeslots.

2. The method of claim 1, wherein transmitting CP information at a portion of CP timeslots when transmitting the CP timeslots comprises:
reserving a portion of the CP timeslots to carry CP information and transmitting no information at the remaining CP timeslots other than the reserved portion of timeslots; or
reserving a portion of the CP timeslots to carry CP information and transmitting information other than the CP information at the remaining CP timeslots other than the reserved portion of timeslots.

3. The method of claim 1, wherein transmitting no CP information at the CP timeslots when transmitting the CP timeslots comprises:
not loading power at the CP timeslots; or transmitting information other than the CP information at the CP timeslots.

4. The method of claim 1, further comprising selecting to perform full-power, or zero-power, or low-power transmission at the CP timeslots according to use of the CP timeslots.

5. The method of claim 2, wherein the step of transmitting information other than the CP information at the CP timeslots comprises:
modulating the information to obtain modulated information; and
time-division-multiplexing the modulated information with the CP.

6. The method of claim 2, wherein, in the case of transmitting information at the CP timeslots, the method further comprises:
transmitting an assignment message to a receiver associated with the information carried in the CP, wherein the assignment message instructs the receiver to use timeslots that carry the information.

7. The method of claim 3, wherein, in the case of transmitting information other than the CP information at the CP timeslots, the method further comprises:
encoding interleaving and scrambling the information to be transmitted.

8. A method for effectively using Cyclic Prefix (CP) timeslots, comprising receiving, by a receiver, a signal transmitted by a transmitter at CP timeslots and obtaining information transmitted by the transmitter according to power change of the signal.

9. The method of claim 8, wherein obtaining information transmitted by a transmitter according to power change of the signal comprises:
testing, by the receiver, the power of the signal received at the CP timeslots,
comparing, by the receiver, test result with a predefined threshold,
determining, by the receiver, the information as “1” if the test result is above the threshold, and determining the information as “0” if the test result is below the threshold; or
determining, by the receiver, the information as “0” if the test result is above the threshold, and determining the information as “1” if the test result is below the threshold; and
obtaining, by the receiver, the information transmitted by the transmitter according to the determination.

10. A method for effectively using Cyclic Prefix (CP) timeslots, the method comprising:
transmitting, by a transmitter, CP information at a portion of CP timeslots;
testing, by a Cognitive Radio (CR) device, the CP;
predicting, by the CR device, periodicity of an idle portion of the CP; and
using, by the CR device, a resource corresponding to the CP if the CR device determines that the resource corresponding to the CP is periodically idle.

11. An apparatus for using Cyclic Prefix (CP) timeslots, the apparatus comprising:
a first transmitting unit adapted to transmit CP information at a portion of CP timeslots when transmitting the CP timeslots; or
a second transmitting unit adapted not to transmit CP information at CP timeslots when transmitting the CP timeslots.

12. The apparatus of claim 11, wherein the first transmitting unit comprises:
a first transmitting module adapted to reserve a portion of the CP timeslots to carry CP information and transmit no information at the remaining CP timeslots other than the reserved portion of timeslots; or
a second transmitting module adapted to reserve a portion of the CP timeslots to carry CP information and transmit information other than the CP information at the remaining CP timeslots other than the reserved portion of timeslots.

13. The apparatus of claim 11, wherein the second transmitting unit comprises:
a third transmitting module adapted not to load power at the CP timeslots; or
a fourth transmitting module adapted to transmit information other than the CP information at the CP timeslots.

14. The apparatus of claim 11, further comprising:
a power controlling unit adapted to control the first transmitting unit or the second transmitting unit to transmit information at full power, or zero power, or low power at the CP timeslots according to use of the CP timeslots.

15. The apparatus of claim 12, wherein the second transmitting module comprises:
a modulating submodule adapted to modulate the information other than the CP information to obtain the modulated information other than the CP information; and
a multiplexing submodule adapted to time-division-multiplex the modulated information other than the CP information with the CP information.

16. The apparatus of claim 13, wherein the fourth transmitting module comprises:
a modulating submodule adapted to modulate the information other than the CP information to obtain the modulated information other than the CP information; and
a multiplexing submodule adapted to time-division-multiplex the modulated information other than the CP information with the CP information.

17. The apparatus of claim 11, wherein the apparatus is a base station or a terminal.

18. The apparatus of claim 17, wherein if the apparatus is a base station, the base station further comprising a broadcasting unit adapted to broadcast a CP information type which indicates use of the CP.

19. The apparatus of claim 11, further comprising a third transmitting unit adapted to send an assignment message to a receiver associated with the information carried in the CP, wherein the assignment message instructs the receiver to use timeslots that carry the information.

20. A receiver for using Cyclic Prefix (CP) timeslots, comprising:
a testing unit adapted to test power of signal received at the CP timeslots;
a comparing unit adapted to compare test result with a predefined threshold, and determine the information as “1” if the test result is above the threshold and determine the information as “0” if the test result is below the threshold; or determine the information as “0” if the test result is above the threshold and determine the information as “1” if the test result is below the threshold; and
an obtaining unit adapted to obtain the information transmitted by the transmitter according to the determination of the comparing unit.
